(19) United States
(12) Patent Application Publication
(10) Pub. No.: US 2013/0133648 A1
(43) Pub. Date: May 30, 2013

(54) SCUBA MOUTHPIECE WITH INTEGRATED LOCKING MECHANISM

(71) Applicants: MIKE BEACH, Miami Beach, FL (US); Blake Burns, Pensacola, FL (US); Ry Doolittle, Hollywood, FL (US)

(72) Inventors: MIKE BEACH, Miami Beach, FL (US); Blake Burns, Pensacola, FL (US); Ry Doolittle, Hollywood, FL (US)

(21) Appl. No.: 13/307,299

(22) Filed: Nov. 30, 2011

(51) Int. Cl. A62B 9/06; A62B 9/04

(52) U.S. Cl. 128/202.27; 128/207.14

(57) ABSTRACT

A mouthpiece polymer body comprising a distal side and a proximal side. The distal side further having a fastener element, and where the fastener element is integrated into the mouthpiece polymer body. A mouthpiece comprising at least one fastener element and a polymer body, where the fastener element is integrated as part of the polymer body. A method to demountably attach/detach a mouthpiece to a regulator comprising using the proximal side of a mouthpiece to create a mechanical advantage to open the distal side of the mouthpiece using a fulcrum. Also using the mouthpiece polymer to provide the elastic force to lock said mouthpiece onto the regulator.

### FIELD OF THE INVENTION

The present invention relates to the art of scuba mouthpieces.

### STATEMENT REGARDING FEDERALLY-SPONSORED RESEARCH AND DEVELOPMENT

Not applicable.

### BACKGROUND OF THE INVENTION

The Frenchman Maurice Fernez, in, or about 1926 invented a diving apparatus that provided a constant-flow of air supply. The Fernez apparatus was mass-produced during the 1930's and was adopted as a standard by the French Navy. He also invented the noseclip, the mouthpiece (equipped with a one-way valve for exhalation) and diving goggles. He also patented the first modern demand regulator and mouthpiece in 1943.

The mouthpiece is a part that the diver grips in his mouth, to make a watertight seal between the breathing set (regulator) and his mouth. Since the times of Fernez, and the beginning of this technology, the mouthpiece has remained the same and with little or no improvement.

The mouthpiece is composed of a short flattened-oval tube that goes in between the lips, on its free end a flange that fits between the lips the tooth and the gums. On the flange there are two projections with enlarged ends, which are gripped between the teeth. Most sport diving scuba sets use a mouthpiece rather than a full-face mask.

One of the main issues with conventional mouthpieces is that they require external “cable-ties” or “zip ties,” i.e. a fastener accessory to tighten the mouthpiece to the regulator mouth. In many industrial breathing sets, and a few scuba sets, the mouthpiece also contains an external tie-in accessory. This “fastener tie-in accessory” makes the mouthpiece more airtight and watertight, and helps to keep the mouthpiece locked to the regulator.

There are several problems with the current external tie-ins. First, they are unreliable, the pressure exerted against the regulator by the mouthpiece is inconsistent and may leak water and air. The second issue is that the mouthpieces are very difficult and uncomfortable to replace. Most dive-shops change their mouthpieces only as they break on rental equipment. Changing mouthpieces, is time-consuming and uncomfortable to do. The zip-ties have to be clipped off and new ones have to be replaced. Even if you bring your own mouthpiece, the removal operation requires the use of scissors, a knife, and both hands. This is particularly difficult for people that are not aquatinted with scuba equipment since they will often cut themselves or the mouthpiece rendering it useless.

Since dive shops change the mouthpieces very seldom, the mouthpieces are used and re-used by the renting diver. This exposes the renting diver to bacteria and other gum and teeth diseases as they spread by using the same mouthpiece by multiple users.

Still, other problems exist in that there is no easy attachment and detachment to the regulators with current mouthpieces. There is a need in the industry to create a mouthpiece that contains an integrated fastener/tie-in element that makes it easy for the diver to plug to the regulator. There is also a further need in the industry to create a mouthpiece where the fastener/tie-in element is strong-enough that it does not need external accessories and at the same time its replacement can be done with one hand and with little effort.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 depicts an embodiment namely, an orthogonal view of the mouthpiece including the integrated fastener.

FIG. 2 depicts an embodiment namely, an orthogonal view of the mouthpiece integrated fastener exploited.

FIG. 3 depicts an embodiment namely, a cross-sectional view of the mouthpiece including the integrated fastener.

FIG. 4 depicts an embodiment namely, an orthogonal view of the mouthpiece including an alternative integrated fastener exploited.

FIG. 5 depicts an embodiment namely, an orthogonal view of the mouthpiece including an alternative integrated fastener.

FIG. 6 depicts an embodiment namely, an orthogonal view of the mouthpiece including an alternative integrated fastener exploited.

FIG. 7 depicts an embodiment namely, an orthogonal view of the mouthpiece including an alternative integrated fastener.

FIG. 8 depicts an embodiment namely, an orthogonal view of the mouthpiece including an alternative integrated fastener exploited.

FIG. 9 depicts an embodiment namely, an orthogonal view of the mouthpiece including an alternative integrated fastener.

FIG. 10 depicts an embodiment namely, an orthogonal cross-sectional view of the mouthpiece including an alternative integrated fastener.

FIG. 11 depicts an embodiment namely, an orthogonal cross-sectional view of the mouthpiece.

FIG. 12 depicts an embodiment namely, an alternative integrated fastener exploited.

FIG. 13 depicts an embodiment namely, an orthogonal view of the mouthpiece including an alternative integrated fastener exploited.

FIG. 14 depicts an embodiment namely, an orthogonal view of the mouthpiece including an alternative integrated fastener.

FIG. 15 depicts an embodiment namely, an orthogonal view of the mouthpiece including an alternative integrated fastener exploited.

FIG. 16 depicts an embodiment namely, an orthogonal view of the mouthpiece including an alternative integrated fastener.

FIG. 17 depicts an embodiment namely, a cross-sectional view of the mouthpiece including the integrated fastener.

FIG. 18 depicts an embodiment namely, an orthogonal cross-sectional view of the mouthpiece including an alternative integrated fastener exploited.

FIG. 19 depicts an embodiment namely, a side view of the mouthpiece including the integrated fastener and how it is attached to a regulator.

FIG. 20 depicts an embodiment namely, a side cross-sectional view of the mouthpiece including the integrated fastener and how it is attached to a regulator.

FIG. 21 depicts an orthogonal view of an example of a regulator to be used in conjunction with this invention.

FIG. 22 depicts an orthogonal view of how to hold a regulator to be used with this invention.

FIG. 23 depicts an orthogonal view of how to adapt an embodiment of the mouthpiece to a regulator.

FIG. 24 depicts an orthogonal view of how the mouthpiece stays on a regulator.

FIG. 25 depicts an orthogonal view of how to detach an embodiment of the mouthpiece to a regulator.

FIG. 26 depicts an embodiment namely, an orthogonal view of the mouthpiece including an alternative integrated fastener.

FIG. 27 depicts an embodiment namely, an cross-sectional view of the mouthpiece including an alternative integrated fastener.

FIG. 28 depicts an embodiment namely, a first front view of the mouthpiece including an alternative integrated fastener.

FIG. 29 depicts an embodiment namely, a second front view of the mouthpiece including an alternative integrated fastener.

FIG. 30 depicts a cross-sectional view of how to adapt an embodiment of the mouthpiece to a regulator.

### DESCRIPTION OF THE INVENTION

The present invention depicts an inventive solution to the fore mentioned issues related to scuba or snorkeling mouthpieces.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the term “fastener,” refers to a locking mechanism that could be either a single part or multiple parts assembled together to hold or demountably couple to a regulator part.

As used herein, the term “integrated,” “in-situ” or “embedded” shall mean; to partially or fully surrounded by another material, or that is partially or fully incorporated as part of the whole structure, or that it is partially or fully inserted within the body of another element.

As used herein, the term “demountably disposed” or “demountably coupled” refers to the placement of two parts wherein the two elements can be removed and placed back together with little effort many times. As a matter of example, and in no means to be used as a limit to the words “demountably coupled,” it comprises the use of; threads, locks, female-male attachments, clips, tapes, adhesives, magnetics, or any combination thereof.

The invention herein comprises a scuba or snorkel mouthpiece with integrated fastener mechanism. Said fastener mechanism comprises at least one hard fastener inserts embedded and surrounded in a softer body, said body further comprising the bite tabs. In general, this invention comprises the integration of a retention mechanism into a diver's mouthpiece in any way as described in this specification an equivalents thereof.

The invention herein aids the diver in consistent attachment and retention by dismountably coupling, mating and engaging, to a scuba regulator or snorkel piece. The ingenious invention creates an easy one-handed assembly/dis-assembly, that incorporates self-alignment. Solving issues with conventional mouthpieces mentioned above. A mouthpiece, such as those used in scuba, having a fastening element or elements integrated into the unit for attachment to mating part. The integration of fastening mechanism and body is such that no secondary or external retaining devices are required for operation.

At least one of the functions of the integrated fastening element or elements is such that a mechanical advantage is gained using the proximal side of the mouthpiece as a fulcrum, internal ramps or contours on the distal side, or a combination of both. The fastening elements may be visible through the body materials for color coded product identification.

The polymer body of the mouthpiece acts as an elastic body aids in the mechanics of the locking mechanism during the assembled state and or during the assembly/dis-assembly sequence.

The configuration of the inserts hold and dismountably couple a regulator part such that there is sufficient force for diving but allow easy removal when pulled, pushed, or twisted in a specific manner. The integration of a mouthpiece soft bitable polymer and integrated fastener mechanism removes the need for any external or separate hardware fasteners such as zips or cable ties. The overall exterior shape of the mouthpiece is conventional but does not have an external groove at the distal end since no zip/cable tie is required to fasten to the regulator flange or lip. This produces an aesthetically appealing streamlined shape joining seamlessly to the regulator.

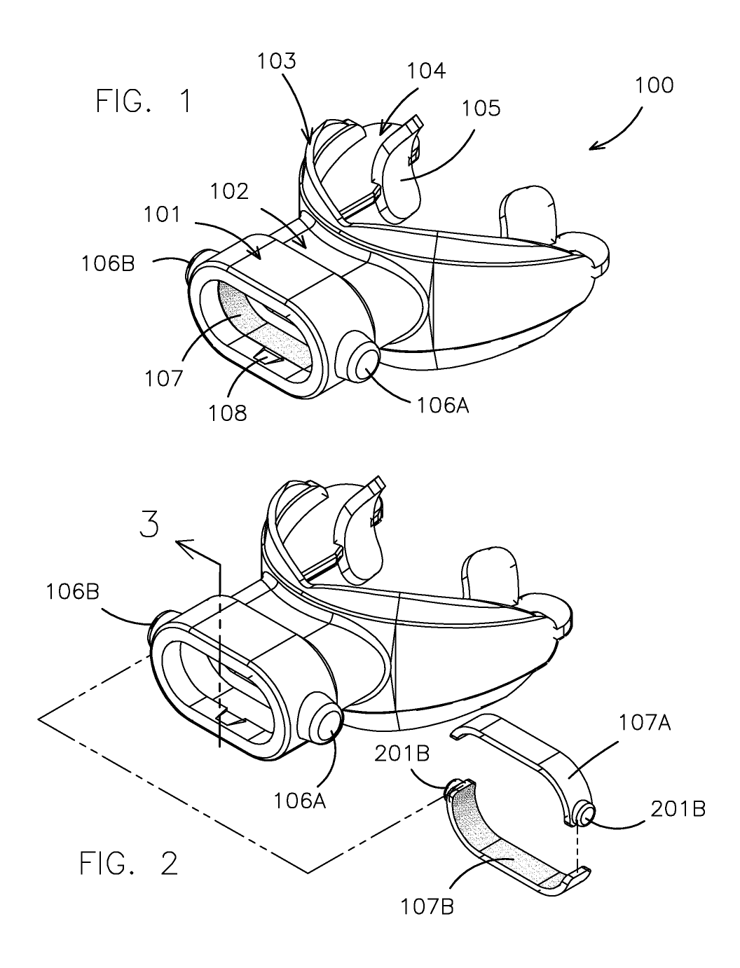

Referring now to the drawings in detail, FIG. 1, 100 depicts an embodiment of the invention. The mouthpiece 100 comprises a soft polymer casing partially surrounding a fastener 107. The fastener 107 in the invention herein may be partially surrounded or fully surrounded with the polymer body that makes part of the distal side 101 of the mouthpiece 100. The complete or partial integration of the fastener 107 to the mouthpiece serve the same function, which is to attach the regulator and in the same way to accomplish the same result.

In the proximal side, the buccal part of the mouthpiece 100, the bite tabs 104 along with the bite guides 105 and the bite flange 103 are found. The proximal side and the distal side is joined by a middle tubular conduit 102. In the invention herein, middle conduit 102, is shorter than in current models, hence a more appealing streamlined mouthpiece is joined seamlessly to the regulator. It is understood that any length of middle conduit 102, would function in the same way to accomplish the same result. An alternative embodiment is to not have a middle conduit 102 at all.

In the distal side of the mouthpiece, the entrance ramp 108 is depicted, and integrated fastener 107. The distal side also depicts a couple of pushbuttons 106A and 106B which are molded out of the same polymer to contour said buttons and engages fasteners buttons 201A and 201B as depicted in FIG. 1. FIG. 2, depicts fastener pieces 107A and 107B respectively. FIG. 2, further depicts the exploited fastener mechanism, namely fastener first element 107A and fastener second element 107B.

In one embodiment of the invention, the fastener first element 107A and fastener second element 107B are mated together from top to bottom, creating two small gaps between the two.

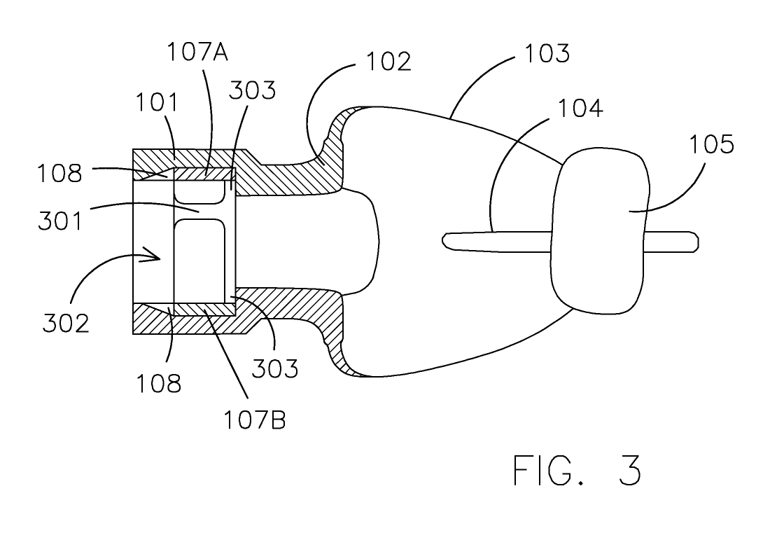

FIG. 3, is a cross-sectional depiction of one embodiment of the invention. Here the ramp 108, is depicted in both the top and the bottom of the inside of the distal 101 part of the mouthpiece. At least one of the purposes of the ramp 108 is to allow for the easy coupling attachment/detachment to the regulator, allowing for the one-handed operation. This ramp can be placed in several positions radially throughout the entrance of the mouthpiece. As the ramp approaches the integrated fastener elements 107A and 107B, it allows the regulator to glide into position resting securely into internal locking space 303. Here, the fastener elements 107A and 107D are fully covered with plastic for a more complete seamless integration.

This cross-sectional view also depicts middle conduit 102, bite tabs 104, bite guides 105 and the bite flange 103. This particular shape of the bite flange 103 is ergonomically modeled to be gentler on the gums of the diver for more comfort and better buccal retention. Between the integrated fastener elements 107A and 107B, the fastener gap or fastener space 301 designed to give room for expansion/contraction to dismountably assemble to the regulator. Fastener gap 301 can be close together in intimate contact or millimeters wide.

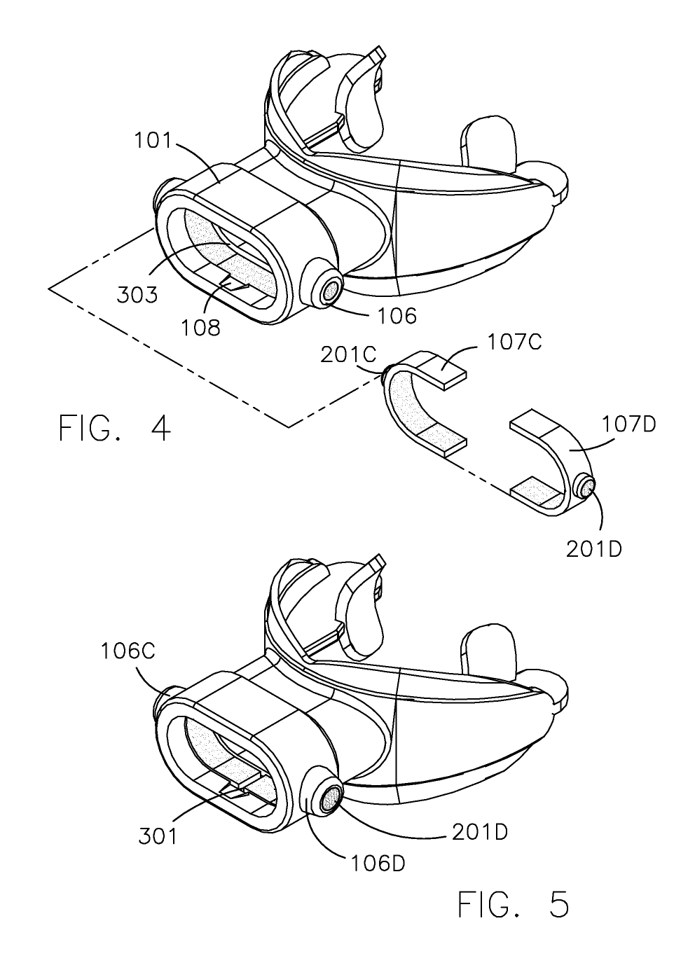

FIG. 4, depicts one embodiment of the invention, here the integrated fastener elements 107C and 107D are arranged in a mirrored wishbone assembly. With the fastener gaps 301 being placed vertically (6 and 12 O'clock positions). Ramps 108 are also placed vertically (6 and 12 O'clock positions) for easy engagement and release. The fastener buttons 201C and 201D are exposed and seen in FIG. 5. When the fastener elements are colored differently than the mouthpiece polymer, the fastener buttons will show-through the mouthpiece polymer at 106C and 106D. Thus, different colors of the fastener buttons 201C and 201D serve to color-code the mouthpieces. Color-coding the mouthpieces will tell the dive-shop owner if the mouthpiece is for a youth or adult, for example.

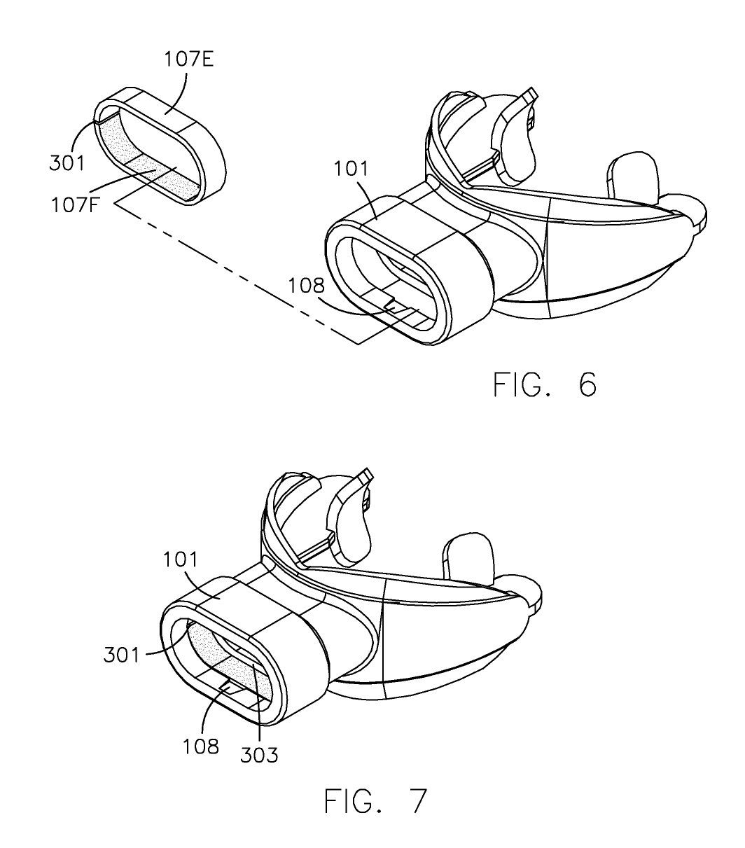

FIG. 6, depicts one embodiment of invention, namely the integrated fastener defining a single gap 301. Note that this particular design does not include any pushbuttons, but does include ramp 108. The main function of the ramp is to slide the regulator lip or flange parallel into the ramp and twist it into position terminating at internal locking space 303 as seen in FIG. 7. This particular embodiment gives back more force as the clam-shaped integrated fastener 107 exerts a higher tensional force against the regulator acting as a spring clip.

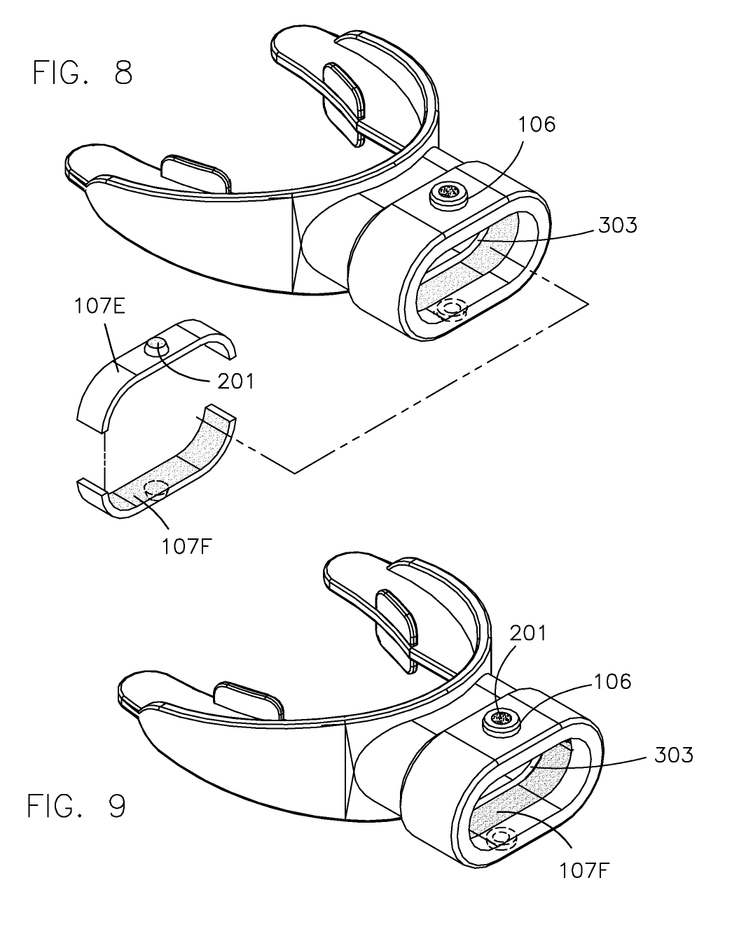

FIG. 8 depicts an alternative embodiment of the inventive mouthpiece. Here the pushbuttons 201 are vertically (12 and 6 O'clock positions) placed engaging with fastener buttons 106. These locations would function in the same way to achieve the same result as seen in FIG. 1 and FIG. 2. Note that this embodiment does not have the previously depicted ramp 108, hence, more force will be needed to dismountably attach/detach the regulator lip to internal space 303. FIG. 9 depicts the assembled mouthpiece having pushbuttons 201 and fastener buttons 106 showing through as fastener 107 is made of a different color than the surrounding mouthpiece.

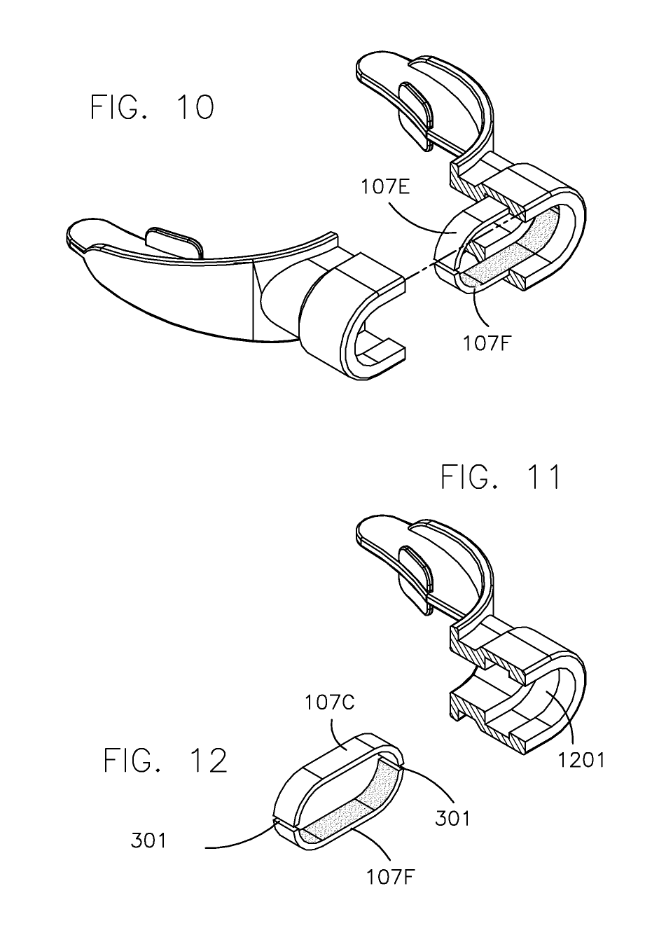

FIG. 10 depicts yet another alternative embodiment of the invention herein. Here, the integrated fastener is divided into element 107E and 107F. This arrangement is better seen exploited in FIG. 11 and FIG. 12 where the cavity 1201 is depicted. This particular configuration creates two gaps 301 between elements 107E and 107F. The force needed for the attachment/detachment using this embodiment was found to be less but the grip to the regulator was also found to be less. Here, the pushbuttons are seamless and integrated into elements 107E and 107F.

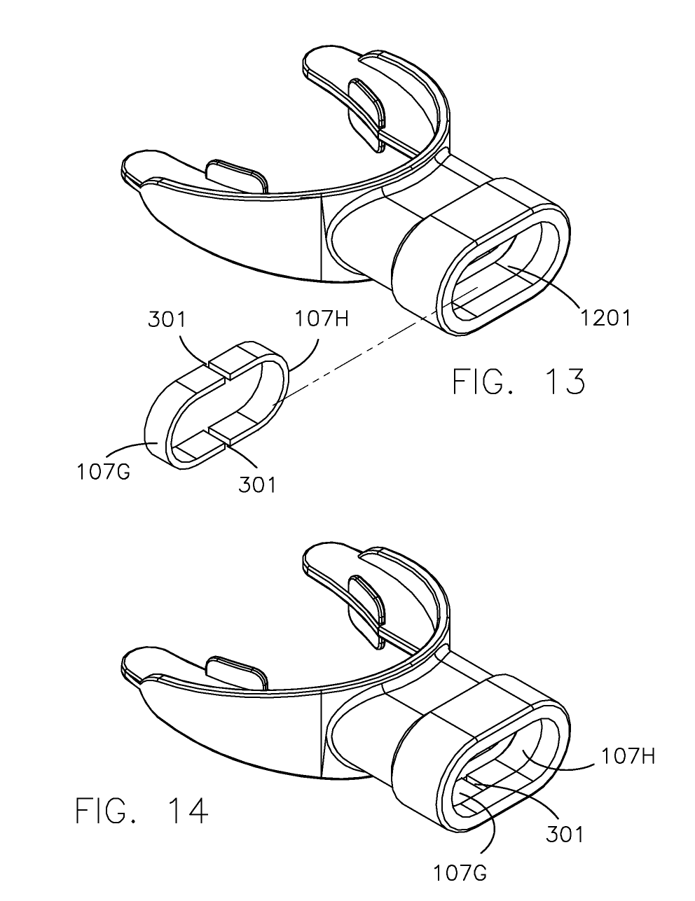

An alternative embodiment is to have the fastener gaps 301 vertically and the fastener elements on both sides as shown in FIG. 13. The exploited fastener elements 107H and 107G, in horseshoe a shape, are mated at the tips. In this particular assembly, depicted in FIG. 14, the attachment/detachment does not include a the entrance ramp 108. Although, a ramp together with this embodiment would complement and also be part of the claimed invention herein.

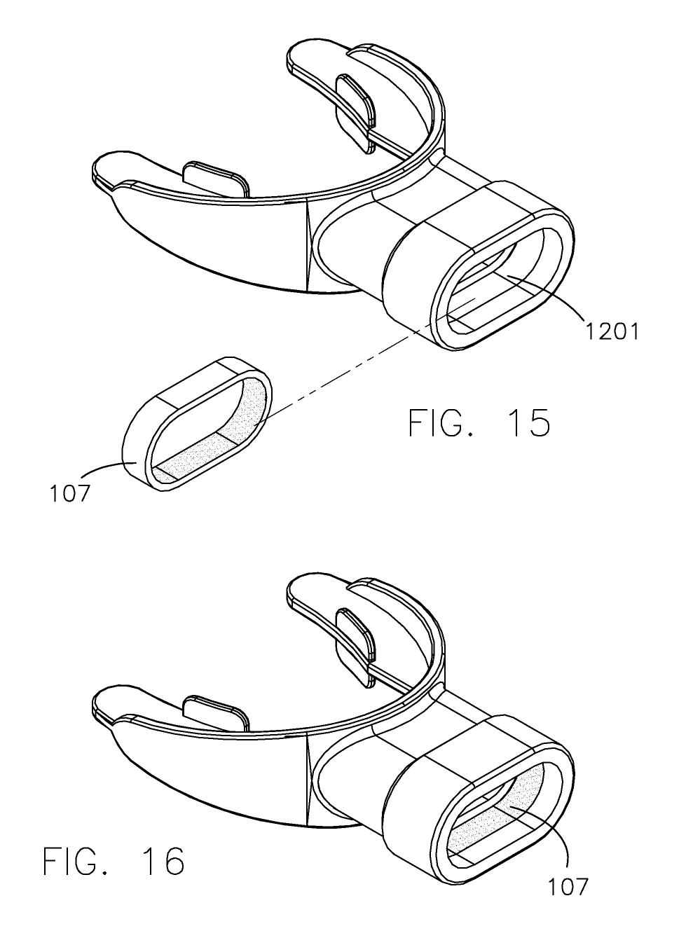

FIGS. 15, 16, 17 and 18, depicts yet another embodiment of the invention herein. Here, there is no gap 301 as part of the integrated fastener 107. The sequence of drawings depict fastener 107 as it can be partially or fully molded into the mouthpiece polymer. Here, cavity 1201 provides a space for the integrated fastener to be placed leaving some space for the regulator to couple.

In one embodiment, the mouthpiece 100 was comprised of two or more polymers of different hardness and temperature over-molded by injection molding. The body of the mouthpiece both the distal and proximal side is made of a soft polymer to provide comfort against the teeth and gums, flexibility and elasticity to the regulator, and act as a hoop spring holding the mouthpiece and integrated fastener 107 tight around the regulator flange or lip made of the harder polymer.

In one of the embodiments, the body of the mouthpiece both the distal and proximal side was made of a 45 durometer (hardness) Shore A black silicone from Stockwell Elastomerics, Inc., this silicone was molded around a 70 durometer (hardness) Shore A Nylon (Polyamide) plastic from BASF Corp. making the integrated fastener 107. It should be understood that similar durometer materials may function in the same way to achieve the same result.

The similar polymers, silicones, thermoplastics and elastomers with similar durometer hardness that may function in the same way to achieve the same result are: Low Density Polyethylene (LDPE), Thermoplastic High Density Polyethylene (HDPE), Polypropylene (PP), Acrylonitrile-Butadiene-Styrene (ABS), PolyvinylChloride (PVC), Polymethylmethacrylate (PMMA), Polytetrafluoroethylene(PTFE), Polyethylene Terephtalate (PET), Nylon 6 (N6), Polyimide (PI), Polycarbonate (PC), and Polysulfone (PSF), EPM (ethylene propylene rubber, a copolymer of ethylene and propylene), EPDM rubber (ethylene propylene diene rubber, a terpolymer of ethylene, propylene and a diene-component), Epichlorohydrin rubber (ECO), Polyacrylic rubber (ACM, ABR) Silicone rubber (SI, Q, VMQ), Fluorosilicone Rubber (FVMQ), Fluoroelastomers (FKM, and FEPM) Viton, Tecnoflon, Fluorel, Aflas, Dai-El, Perfluoroelastomers, (FFKM) Tecnoflon PFR, Kalrez, Chemraz, Perlast, Polyether block amides (PEBA), Chlorosulfonated polyethylene (CSM), (Hypalon), Ethylene-vinyl acetate (EVA), and any combinations thereof.

In another embodiment, the body of the mouthpiece both the distal and proximal side is made of a 40 durometer (hardness) Shore A black silicone from Stockwell Elastomerics, Inc., this was molded around a extruded and aluminum piece making the integrated fastener 107. The integrated fastener 107 can be made of other metals such as stainless steel and other non-oxidizing metals.

In yet another embodiment of the invention, the integrated fastener 107 has same material as the body of the mouthpiece. Here, both the distal and proximal side is made of a 65A Shore A, durometer (hardness) silicone from Stockwell Elastomerics, Inc. This would allow for the use the entrance ramp 108 in a homogeneous body as long as the body material is sufficiently hard. Again, similar durometer materials may function in the same way to achieve the same result as described above.

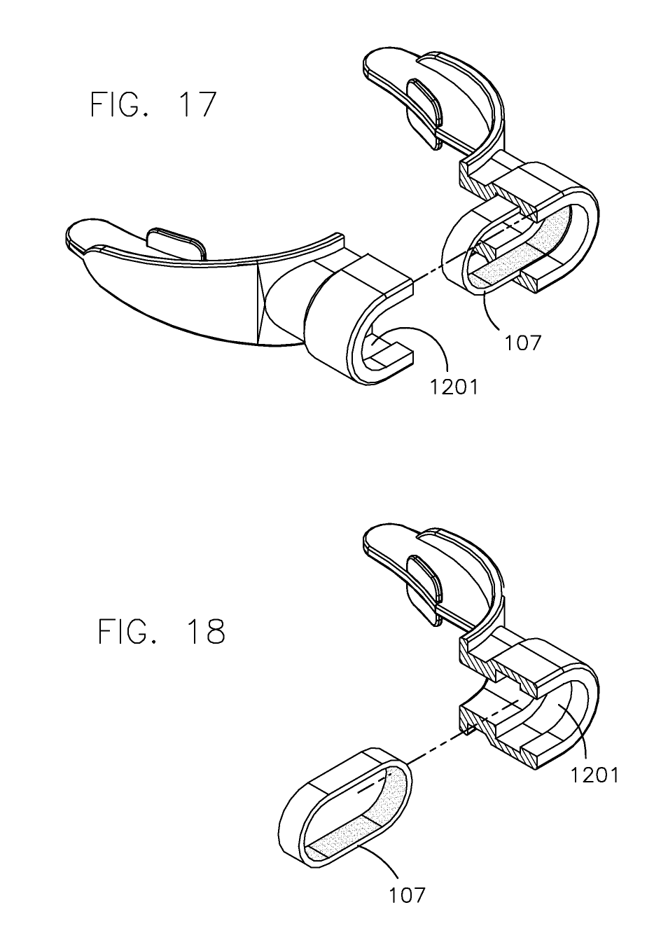

As seen in FIGS. 17 and 18, the harder polymer of metallic fastener embedded in the distal end of the mouthpiece, locks against the regulator flange and prevent its removal during diving. The fastener may be a single continuous unit, as in 107, or comprised of multiple over-molded parts as in the previous figures.

Soft polymer or silicone mouthpiece body may also include materials to be dishwasher safe, have anti-microbial chemical additives, and anti-microbial surface texture. Other features may include an extended soft bite design or other bite tab configurations. A moisture retention plate may be included as a load bearing component of the actual locking mechanism embedded in the mouthpiece.

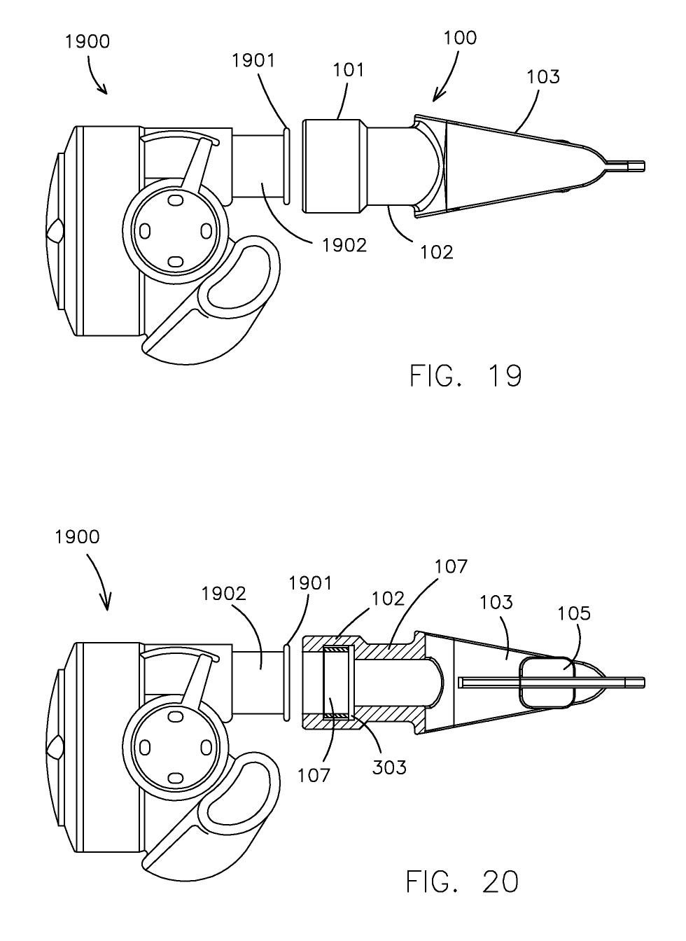

FIG. 19, depicts the attachment and retention by dismountably coupling and engaging the mouthpiece body 100, to a scuba regulator 1900. Here, the regulator lip 1901 and regulator neck 1902 engages the distal part 101 and the diver bites on the proximal side 103. In cross-section FIG. 20, a more detailed view of the dismountable coupling, wherein the regulator lip 1901 and neck 1902 enter the distal side 101 and it expands due to the elasticity found in the polymer body. As it enters, it encounters the integrated fastener 107, which is made of a harder material. It expands as the lip 1902 enters and finally contracts as it rests in the final cavity 303 locking into place. The contraction and expansion of the integrated fastener 107 is aided and amplified by the pushbuttons shown above or by simply squeezing on the distal side 102 respectively.

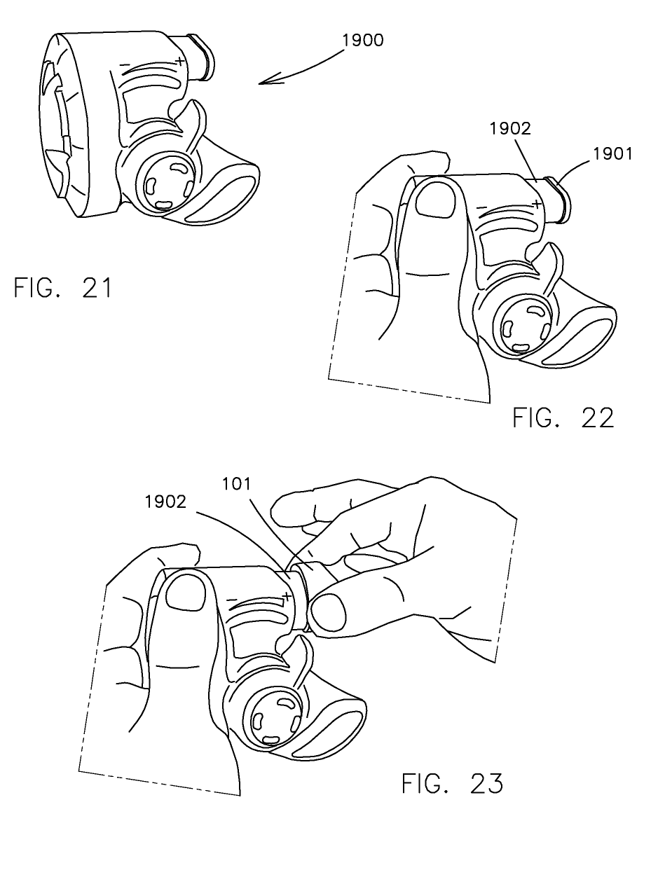

As seen in sequence FIGS. 21, 22, 23, 24, and 25, the invention herein provides a simple method of coupling a mouthpiece 100 to a regulator 1900. The single mouthpiece body and integrated fastener removes the need for additional hardware typically needed for mounting to the regulator 1900 comprising a regulator lip 1901 and neck 1902.

To assemble the two, FIG. 23, the user squeezes the distal end 101 of the mouthpiece between thumb and forefinger and pushes the mouthpiece onto the regulator neck 1902 overcoming the lip 1901 and neck 1902 seen in FIG. 22. During this pressing operation, it may be advantageous to push while rotating from bottom to top so the lower, chin side, mouthpiece insert snaps onto the regulator before the top, nose side, insert.

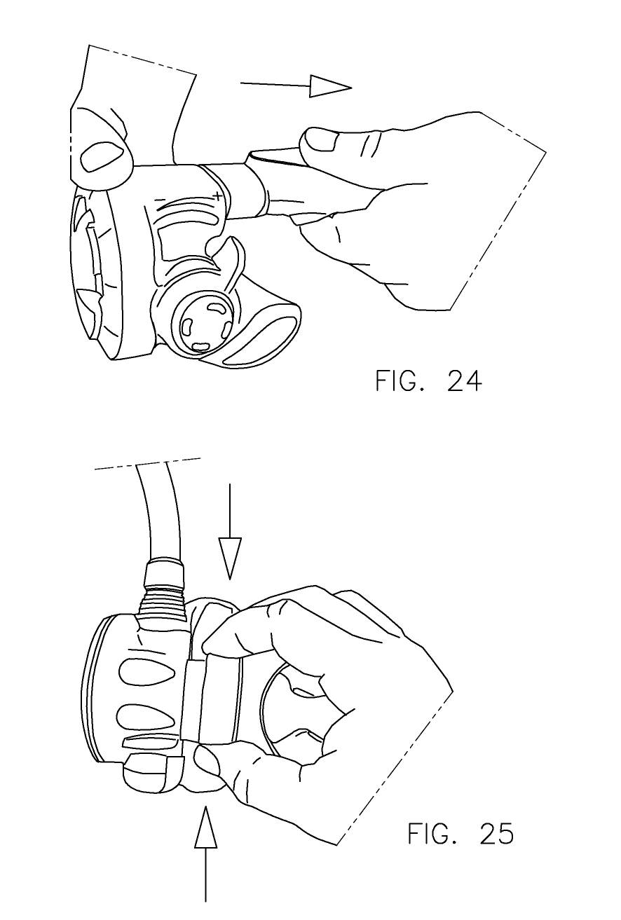

Once assembled, both inserts are bound tightly to the regulator around the full circumference of the regulator flange and prevent removal by diving load scenarios FIG. 24. Additionally, the compression from the diver's mouth and lips helps to secure the joint and prevents any miss-step of the removal process. To remove, the user goes through the assembly instructions in reverse.

As seen in FIG. 25, the user squeezes the left and right of the distal end of the mouthpiece at the location of overlap to the regulator 1900. The user then lifts the top insert up and away from the upper regulator lip and pulls away while rotating from top to bottom. This process frees the top then bottom insert allowing easy one-handed removal. This motion cannot be accomplished during diving.

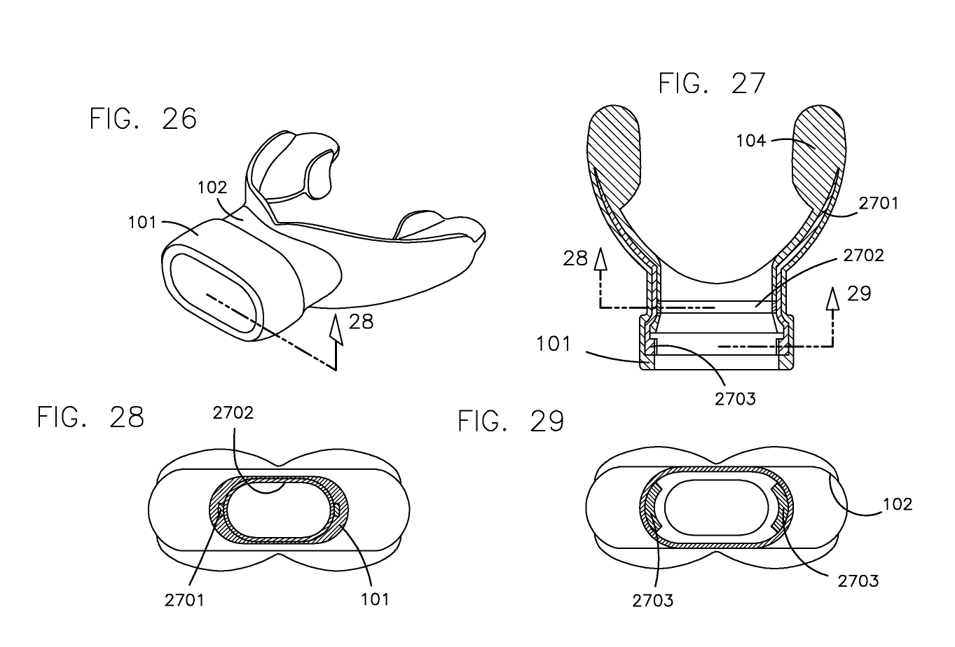

FIG. 26, depicts another alternative embodiment to the invention herein. Here, the mouthpiece 100 comprises the easiest way to quickly demountable detach/attach the mouthpiece to a regulator 1900. In cross-section FIG. 27, the internal integrated elongated fastener 2701 is depicted in detail. Here, a mechanical advantage is created to open the distal end 101 of the mouthpiece by pressing on the proximal side of the mouthpiece 100 body. This embodiment comprises an elongated integrated fastener 2701 going from the proximal to the distal side bypassing over the fulcrum ring 2702. On the distal side of the elongated integrated fastener 2701 is the locking clip 2703. This locking clip 2703 holds the regulator lip 1901 in place.

FIG. 28 depicts is a detailed cross-section of the distal part 101 of the mouthpiece. Here, the lever ring 2702 is shown, that acts as a “fulcrum” and gives the mechanical advantage to the elongated integrated fastener 2701. FIG. 29 is a detailed cross-section of the distal part 101 of the mouthpiece. Here, the locking clips 2703 holds the regulator lip in place can be seen.

The mechanical advantage is the measure of the force amplification achieved by using a mechanical device. Here, the mouthpiece device preserves the input power at the proximal end and trades off forces against movement in distal end to obtain a desired amplification in the output force. The model for this is the law of the lever.

$$MA = \frac{{F}_{B}}{{F}_{A}} = \frac{a}{b} .$$

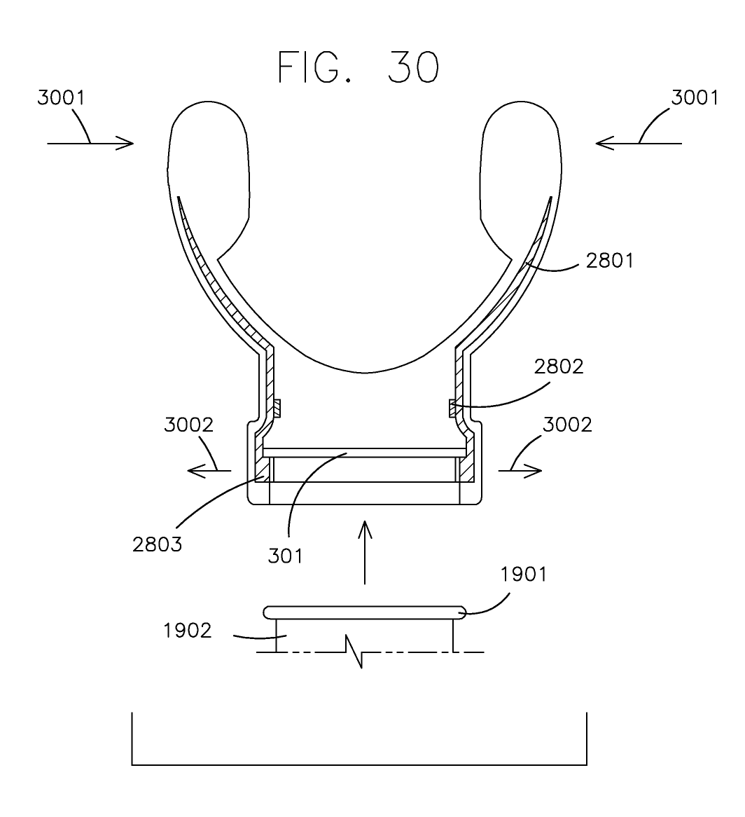

As seen in FIG. 30, it shows that if the distance from the fulcrum 2802 to where the input force is applied 3001 is greater than the distance from fulcrum 2802 to where the output force is applied 3002, then the lever amplifies the input force 3001.

The mouthpiece body, being moldable, made out of the elastic materials mentioned above, serves as a spring and forces the locking clips 2103 against the regulator lip 2901 and regulator neck 1902. The result is a large force against the regulator lip 2901 and tremendous mechanical advantage of the input force as applied in 3001 can now be employed to quickly detach/attach the mouthpiece to a regulator, greatly reducing the required muscle effort. In addition, fulcrum ring 2702 was constructed out of aluminum with a more rigid material. Other hard plastics could also be used, or metals comprising brass, stainless steel, copper, and combinations thereof.

The significant reduction in muscle effort required to detach/attach the mouthpiece using the embodiment of FIG. 30, has been confirmed with electromyographic tests. Test data demonstrated a reduction of muscle effort in the range of 43% to 89%, depending upon the individual person.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

We claim:

1. A mouthpiece polymer body, comprising:
a distal side, said distal side further comprising at least one fastener element; and
a proximal side, wherein said fastener element is integrated into said mouthpiece polymer body.

2. The mouthpiece of claim 1, wherein said proximal side further comprises at least one bite tab, at least one bite guide, and at least one bite flange.

3. The mouthpiece of claim 1, wherein the distal side and the proximal side are joined by a middle tubular conduit.

4. The mouthpiece of claim 1, wherein said at least one fastener element further comprises at least one pushbutton.

5. The mouthpiece of claim 1, wherein the said distal side defines at least one ramp.

6. The mouthpiece of claim 1, wherein the said at least one fastener element is partially integrated into the mouthpiece polymer body.

7. The mouthpiece of claim 1, wherein the said at least one fastener element is fully integrated into the mouthpiece polymer body.

8. The mouthpiece of claim 1, wherein the said at least one fastener element is colored different than the surrounding mouthpiece polymer body.

9. The mouthpiece of claim 1, wherein the said at least one fastener element defines at least one internal gap.

10. A mouthpiece, comprising:
at least one fastener element, said fastener element made of a first durometer hardness;
and
a polymer body, said polymer body made of a second duromerter hardness; wherein said at least one fastener element is integrated as part of said polymer body.

11. The mouthpiece of claim 10, wherein the said polymer body is selected form the group consisting of; Low Density Polyethylene (LDPE), Thermoplastic High Density Polyethylene (HDPE), Polypropylene (PP), Acrylonitrile-Butadiene-Styrene (ABS), PolyvinylChloride (PVC), Polymethylmethacrylate (PMMA), Polytetrafluoroethylene (PTFE), Polyethylene Terephtalate (PET), Nylon 6 (N6), Polyimide (PI), Polycarbonate (PC), and Polysulfone (PSF), EPM (ethylene propylene rubber, a copolymer of ethylene and propylene), EPDM rubber (ethylene propylene diene rubber, a terpolymer of ethylene, propylene and a diene-component), Epichlorohydrin rubber (ECO), Polyacrylic rubber (ACM, ABR) Silicone rubber (SI, Q, VMQ), Fluorosilicone Rubber (FVMQ), Fluoroelastomers (FKM, and FEPM) Viton, Tecnoflon, Fluorel, Aflas and Dai-El, Perfluoroelastomers (FFKM) Tecnoflon PFR, Kalrez, Chemraz, Perlast, Polyether block amides (PEBA), Chlorosulfonated polyethylene (CSM), (Hypalon), Ethylene-vinyl acetate (EVA), and any combinations thereof.

12. The mouthpiece of claim 10, wherein said proximal side further comprises at least one bite tab, at least one bite guide, and at least one bite flange.

13. The mouthpiece of claim 10, wherein the distal side and the proximal side are joined by a middle tubular conduit.

14. The mouthpiece of claim 10, wherein said at least one fastener element further comprises at least one pushbutton.

15. The mouthpiece of claim 10, wherein the said distal side defines at least one ramp.

16. The mouthpiece of claim 10, said mouthpiece further comprising a fulcrum ring, wherein said fulcrum ring provides a lever point for said at least one fastener element.

17. A method to demountably attach/detach a mouthpiece to a regulator, comprising:
using the proximal side of a mouthpiece to create a mechanical advantage to open the distal side of said mouthpiece using a fulcrum; and
using the said mouthpiece polymer to provide the elastic force to lock said mouthpiece to said regulator.

18. The method of claim 17, wherein the said distal side and the said proximal side are joined by a middle tubular conduit.

19. The method of claim 17, wherein the said mouthpiece further comprises at least one fastener element that is partially integrated into the mouthpiece polymer body.

20. The method of claim 17, wherein the said mouthpiece further comprises at least one fastener element that is fully integrated into the mouthpiece polymer body.
